(19) United States
(12) Patent Application Publication
(10) Pub. No.: US 2019/0120786 A1
(43) Pub. Date: Apr. 25, 2019

(54) EXTERNAL SENSOR FOR MEASURING A CONCENTRATION OF AN ION

(71) Applicant: Endress+Hauser Conducta GmbH+Co. KG, Gerlingen (DE)

(72) Inventors: Jens Vettermann, Grossweitzschen (DE); Stephan Jugert, Dresden (DE); Erik Hennings, Freiberg (DE)

(21) Appl. No.: 16/170,129

(22) Filed: Oct. 25, 2018

(30) Foreign Application Priority Data
Oct. 25, 2017 (DE) 10 2017 124 938.9

(51) Int. Cl. G01N 27/333; G01N 27/30

(52) U.S. Cl. CPC G01N 27/333; G01N 27/301

(57) ABSTRACT

The present disclosure relates to a sensor for measuring a concentration of an ion dissolved in a measuring solution, comprising a plurality of ion-selective electrodes each having a sensitive surface for contact with the measuring solution, wherein the electrodes comprise consumed and unconsumed electrodes, a reference electrode for contact with the measuring solution, wherein a measured value of an electrical voltage between one of the unconsumed electrodes and the reference electrode is a measure of the concentration of the ion dissolved in the measuring solution, and a measuring transducer for determining the measured value of the voltage and for converting the measured value into a concentration of the ion. The measuring transducer has a switching unit to activate an unconsumed electrode and to deactivate all other electrodes, and the sensitive surfaces of unconsumed electrodes each have a cover covering the sensitive surface against the measuring solution in a medium-tight manner.

### CROSS-REFERENCE TO RELATED APPLICATION

The present application is related to and claims the priority benefit of German Patent Application No. 10 2017 124 938.9, filed on October 25, 2017, the entire contents of which are incorporated herein by reference.

### TECHNICAL FIELD

The present disclosure relates to a sensor for measuring a concentration of an ion dissolved in a measuring solution using ion-selective electrodes.

### BACKGROUND

Ion-selective electrodes are frequently used in the process industry, for example in water management, and measure, for example, ions dissolved in the water, such as ammonium, potassium, nitrate and chloride. Over the duration of use of an ion-selective electrode, however, the performance decreases continuously until the end of the operability of the electrode. This results from leakages or inadequate resistance to surfactants or other impurities. Thus, in part, depending on the operating condition, only a short lifetime of such a sensor is achieved. The electrode becomes unusable and has to be replaced early. To this end, either the entire sensor, a membrane cap or a whole cartridge can be replaced depending on the manufacturer. This is very complex and also produces waste. It is desirable to extend the duration of use of sensors with ion-selective electrodes.

### SUMMARY

The object of the present disclosure is to provide a sensor for measuring a concentration of an ion dissolved in a measuring solution, the electrodes of which sensor can be exchanged in a simplified manner and with little waste.

The object is achieved by the subject matter of the present disclosure. The present disclosure relates to a sensor for measuring a concentration of an ion dissolved in a measuring solution, comprising:

a plurality of ion-selective electrodes each having a sensitive surface for contacting the measuring solution, wherein the electrodes comprise consumed and unused electrodes;

a reference electrode for contacting the measuring solution, wherein a measured value of an electrical voltage between one of the electrodes and the reference electrode is a measure of the concentration of the ion dissolved in the measuring solution; and

a measuring transducer for determining the measured value of the voltage and for converting the measured value into the concentration of the ion, wherein:

the measuring transducer has a switching unit for activating an unused electrode and for deactivating all other electrodes, and

the sensitive surfaces of unused electrodes each have a cover, which covers the surface against the measuring solution in a medium-tight manner.

The switching unit has a channel for each electrode. The operator switches to a channel with an unused electrode on the measuring transducer in order to activate this electrode. This electrode is factory-calibrated and provides a correct measured value with little deviation. The previously used channel is switched off by switching to another channel. Tempering to the measuring solution is dispensed with, just like a run-in of the reference electrode, since all the electrodes are already contacted with the medium.

The ion-selective electrodes can already be calibrated under the cover and/or stored in the electrolyte in order to avoid drying out. The active electrode is thus immediately ready for use. Through the use of several successively activatable electrodes for measuring the ion concentration, the lifetime of the sensor can be extended many times. The chambers are insulated from the environment by the cover as long as necessary.

According to one embodiment, the sensor has a receiving unit for receiving the electrodes, wherein the electrodes are each arranged in a chamber of the receiving unit.

According to another embodiment, at least one of the covers closes a chamber in a medium-tight manner against the measuring solution. Only the cover in the form of a thin film is produced here as waste. The maintenance effort is therefore very low and consists only of removing the cover.

According to another embodiment, the sensor is configured to push an inactive electrode from the chamber through the cover. This may be achieved using a mechanical unit which can be moved axially in the direction of the measuring solution. This can be done either by the measuring element of the electrode using a knob, or by using a motor or a linear unit via the measuring transducer.

According to another embodiment, the at least one of the covers has a tab for pulling off the cover.

According to another embodiment, at least one of the covers is a membrane, a cap or a cover. The membrane can be applied to the receiving unit or to the electrode via the sensitive surface of the electrodes, which has not yet been activated and thus may be protected, for example, by ultrasonic welding.

According to another embodiment, the receiving unit is cylindrical.

According to another embodiment, the receiving unit is configured as a turret drum.

According to another embodiment, the turret drum includes a rotatable cover disk having an opening rotatably disposed about a longitudinal axis of the turret drum in such a manner that the opening exposes only one electrode defining the active electrode.

The cover disk functions similarly to a rotating dial of a telephone. After consumption of the active electrode, the operator selects a still inactive electrode on the measuring transducer, and the still inactive electrode is automatically switched to active by means of an actuator (e.g., stepper motor or manually rotating dial).

According to another embodiment, the turret drum comprises a cover disk having an opening arranged about a longitudinal axis of the rotatable turret drum such that the opening exposes only one electrode defining the active electrode. Here, the cover disk functions similarly to a turret.

In a further embodiment, the measuring system has a diagnostic functionality which automatically monitors the active electrode and selects and activates an inactive electrode automatically with corresponding consumption. Information is then given to the process control point or measuring transducer about the remaining operational life of the sensor with the remaining inactive electrodes.

### BRIEF DESCRIPTION OF THE DRAWINGS

The present disclosure is explained in more detail based upon the following drawings.

FIG. 1 shows a side view of a receiving unit, designed as a turret drum, of a sensor for measuring an ion concentration;

FIG. 2 shows a front view of a turret drum-shaped receiving unit according to FIG. 1;

FIG. 3 shows a side view of another receiving unit, designed as a turret drum, with a cover disk; and

FIG. 4 shows a front view of a turret drum-shaped receiving unit according to FIG. 3.

### DETAILED DESCRIPTION

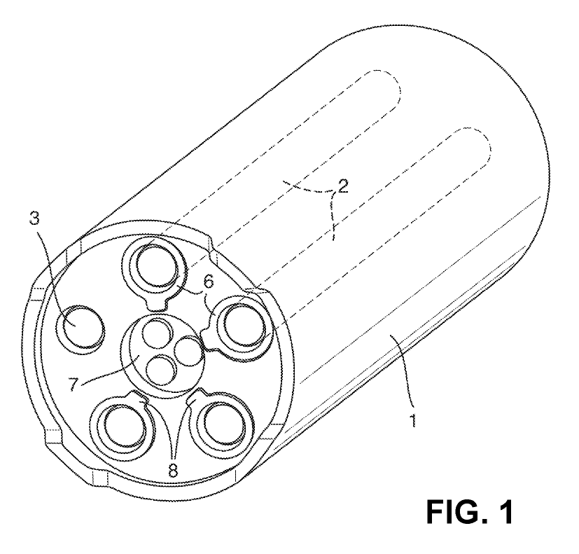

FIG. 1 shows a side view of a receiving unit 1, designed as a turret drum, of a sensor for measuring an ion concentration, here of an ammonium ion. The receiving unit 1 comprises five chambers 2, the longitudinal axes of which are arranged parallelly to a longitudinal axis of the receiving unit 1 around the latter. The chambers 2 each have an opening on one end face of the receiving unit 1.

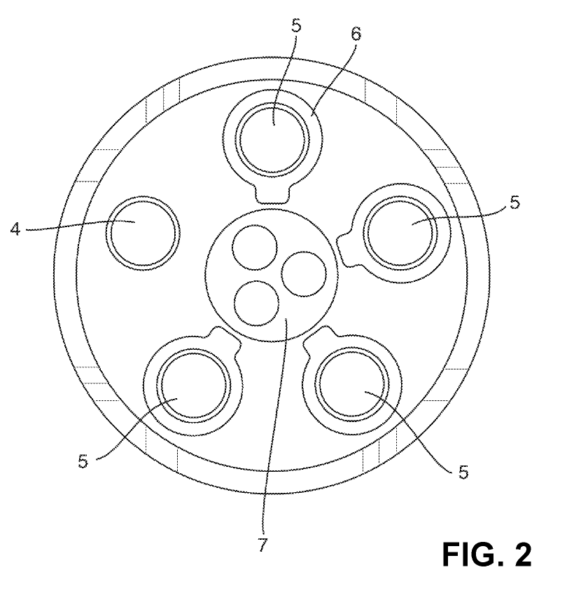

An ion-selective electrode 3 is arranged within each chamber 2. Of the five chambers 2, four have a cover 6 which seals the chambers 2 in a medium-tight manner. The covers 6 each have a tab 8 for pulling off the cover 6. One chamber 2 is cover-free. The electrodes 3, which are arranged within a chamber 2 with a cover 6, have no contact with the measuring solution. The cover 6 functions here as a protective film, so that the covered electrodes 3 remain unconsumed. A sensitive surface of the cover-free electrode 3 can be contacted directly with the measuring solution. Referring also to FIG. 2, the cover-free electrode 3 is the currently active electrode 4. All other electrodes 3 are inactive electrodes 5.

A reference electrode 7 for contact with the measuring solution is arranged centrally to the longitudinal axis of the receiving unit 1. The reference electrode 7 is centered so that it is not affected by the cover and the dialing operation.

A measured value of an electrical voltage between the active electrode 4 and the reference electrode 7 is a measure of the concentration of the ion dissolved in the measuring solution. A measuring transducer (not shown) determines the measured value of the voltage and converts the measured value into a concentration of the ion. The measuring transducer has a switching unit (not shown) configured to measure the electrical voltage between the active cover-free electrode 4 and the reference electrode 7.

When the active electrode 4 is consumed, the cover 6 of one of the unused electrodes 5 is pulled off by means of its tab 8 and the associated electrode 5 is activated by means of the switching unit of the measuring transducer. The originally active electrode 4 becomes an inactive consumed electrode 5. The following measurements are made with reference electrode 7 and the active electrode 4.

FIG. 2 shows a front view of the turret drum-shaped receiving unit 1 according to FIG. 1.

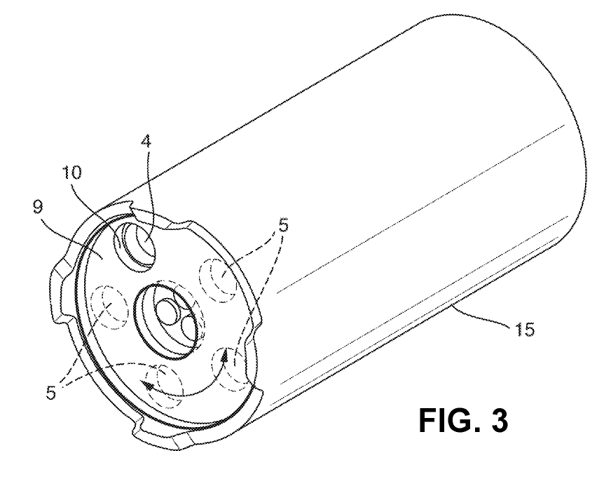

FIG. 3 shows a side view of another receiving unit 15, designed as a turret drum, with a cover disk 9. In contrast to the receiving unit 1 according to FIG. 1, the chambers 2 are not covered by covers 6. Instead, the receiving unit 15 has a cover disk 9 with an opening 10. The cover disk 9 is rotatably mounted and rotates about the longitudinal axis of the receiving unit 15. Referring also to common features of receiving unit 15 and receiving unit 1 of FIGS. 1 and 2, the cover disk 9 is arranged on the end face of the receiving unit 15 in such a way that the opening 10 exposes a chamber 2 and seals all other chambers 2 in a medium-tight manner. The exposed chamber 2 is the chamber 2 with the active electrode 4 and the other covered chambers 2 are the chambers 2 with the inactive electrodes 5.

Alternatively, the cover disk 9 can be fixedly mounted and the turret drum-shaped receiving unit 15 can be rotatably mounted.

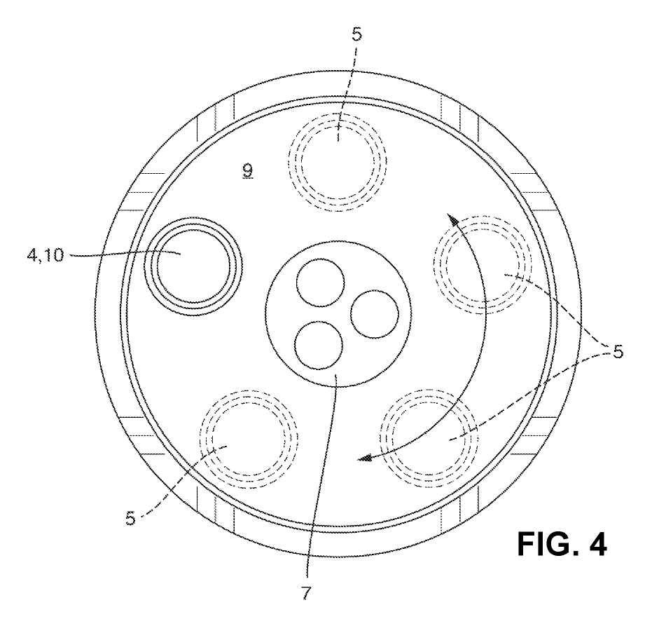

FIG. 4 shows a front view of the turret drum-shaped receiving unit 15 according to FIG. 3.

1. A sensor for measuring a concentration of an ion dissolved in a measuring solution, comprising:
a plurality of ion-selective electrodes each having a sensitive surface for contact with the measuring solution, wherein the electrodes comprise consumed and unconsumed electrodes;
a reference electrode for contacting the measuring solution, wherein a measured value of an electrical voltage between one of the unconsumed electrodes and the reference electrode is a measure of the concentration of the ion dissolved in the measuring solution; and
a measuring transducer for determining the measured value of the voltage and for converting the measured value into a concentration of the ion, wherein:
the measuring transducer has a switching unit for activating an unused electrode and for deactivating all other electrodes; and
the sensitive surfaces of unused electrodes each have a cover which covers the sensitive surface against the measuring solution in a medium-tight manner.

2. The sensor according to claim 1, wherein the sensor has a receiving unit for receiving the electrodes, and wherein the electrodes are each arranged in a chamber of the receiving unit.

3. The sensor according to claim 1, wherein at least one of the covers seals a chamber in a medium-tight manner against the measuring solution.

4. The sensor according to claim 3, wherein the sensor has means for pushing an inactive electrode from the chamber through the cover.

5. The sensor according to claim 1, wherein at least one of the covers has a tab for pulling off the cover.

6. The sensor according to claim 1, wherein at least one of the covers is a membrane, a cap or a cover.

7. The sensor according to claim 1, wherein the receiving unit is cylindrical.

8. The sensor according to claim 1, wherein the receiving unit is designed as a turret drum.

9. The sensor according to claim 8, wherein the turret drum comprises a rotatable cover disk having an opening rotatably arranged about a longitudinal axis of the turret drum in such a way that the opening exposes only one electrode defining an active electrode.

10. The sensor according to claim 8, wherein the turret drum comprises a cover disk having an opening arranged about a longitudinal axis of the rotatable turret drum such that the opening exposes only one electrode defining an active electrode.
